(19) United States
(12) Patent Application Publication
(10) Pub. No.: US 2021/0343239 A1
(43) Pub. Date: Nov. 4, 2021

(54) DISPLAY DRIVING METHOD OF INTEGRATED CIRCUIT, INTEGRATED CIRCUIT, DISPLAY SCREEN AND DISPLAY APPARATUS

(71) Applicant: BOE TECHNOLOGY GROUP CO., LTD., Beijing (CN)

(72) Inventor: Wenjing TAN, Beijing (CN)

(73) Assignee: BOE TECHNOLOGY GROUP CO., LTD., Beijing (CN)

(21) Appl. No.: 16/335,110

(22) PCT Filed: Jul. 25, 2018
(86) PCT No.: PCT/CN2018/097039

§ 371 Date: Mar. 20, 2019

(30) Foreign Application Priority Data
Sep. 30, 2017 (CN) 201710914894.9

(51) Int. Cl. G09G 3/3258

(52) U.S. Cl. CPC G09G 3/3258; G09G 2340/0457; G09G 2310/0232; G09G 2320/0673; G09G 2310/027

(57) ABSTRACT

A display driving method of a plurality of integrated circuits, a display driving method, a display driving integrated circuit, a display screen and a display apparatus. The plurality of integrated circuits includes a first integrated circuit and a second integrated circuit, and the display driving method includes: sending current boundary pixel data driven by the first integrated circuit to the second integrated circuit; and carrying out a sub-pixel rendering calculation in the second integrated circuit on the current boundary pixel data and current sub-pixel data stored in the second integrated circuit to correct the current sub-pixel data.

The present application claims priority to Chinese Patent Application No. 201710914894.9 filed on Sep. 30, 2017, the disclosure of which is incorporated herein by reference in its entirety as part of the present application.

### TECHNICAL FIELD

Embodiments of the present disclosure relate to a display driving method of a plurality of integrated circuits, a display driving method of an integrated circuit, a display driving integrated circuit, a multi-integrated circuit-driven display screen and a display apparatus.

### BACKGROUND

In recent years, an Organic Light-Emitting Diode (OLED) display screen has attracted great attention due to its advantages such as wide color gamut, a high response speed, low power consumption, and has gradually occupied the market in the fields of a mobile phone, a tablet personal computer, a television and so on.

### SUMMARY

At least an embodiment of the present disclosure provides a display driving method of a plurality of integrated circuits, wherein the plurality of integrated circuits comprises a first integrated circuit and a second integrated circuit, the display driving method comprises: sending current boundary pixel data driven by the first integrated circuit to the second integrated circuit; and carrying out a sub-pixel rendering calculation in the second integrated circuit on the current boundary pixel data and current sub-pixel data stored in the second integrated circuit to correct the current sub-pixel data.

For example, in the display driving method of the plurality of integrated circuits according to an embodiment of the present disclosure, the current boundary pixel data is current pixel data which is positioned at a junction of two adjacent driven regions in a display screen and driven by the first integrated circuit.

For example, in the display driving method of the plurality of integrated circuits according to an embodiment of the present disclosure, the carrying out the sub-pixel rendering calculation in the second integrated circuit on the current boundary pixel data and the current sub-pixel data stored in the second integrated circuit comprises: arranging the driven regions transversely side by side, the current boundary pixel data being a longitudinal pixel at the junction of the adjacent driven regions, and carrying out the sub-pixel rendering calculation on the current boundary pixel data and the current sub-pixel data by transverse color borrowing; or, arranging the driven regions longitudinally side by side, the current boundary pixel data being a transverse pixel at the junction of the adjacent driven regions, and carrying out the sub-pixel rendering calculation on the current boundary pixel data and the current sub-pixel data by longitudinal color borrowing.

For example, in the display driving method of the plurality of integrated circuits according to an embodiment of the present disclosure, the current boundary pixel data is a voltage signal.

For example, the display driving method of the plurality of integrated circuits according to an embodiment of the present disclosure further comprises: reading grayscale information of a boundary pixel by the first integrated circuit, and carrying out a gamma operation on the grayscale information to obtain the voltage signal; and carrying out a de-gamma operation on the voltage signal by the second integrated circuit to obtain the grayscale information, and carrying out by the second integrated circuit the sub-pixel rendering calculation on the grayscale information and the current sub-pixel data stored in the second integrated circuit.

For example, the display driving method of the plurality of integrated circuits according to an embodiment of the present disclosure further comprises: sending current boundary pixel data driven by the second integrated circuit to the first integrated circuit; and carrying out a sub-pixel rendering calculation in the first integrated circuit on the current boundary pixel data driven by the second integrated circuit and current sub-pixel data stored in the first integrated circuit.

At least an embodiment of the present disclosure further provides a display driving method of an integrated circuit, which comprises: receiving current boundary pixel data in another integrated circuit; carrying out a sub-pixel rendering calculation on current sub-pixel data stored in the integrated circuit based on the current boundary pixel data to obtain compensated pixel data; and transmitting the compensated pixel data to a driven region connected with the integrated circuit to drive the driven region to display.

At least an embodiment of the present disclosure further provides a display driving integrated circuit, which comprises: a first input end, configured to receive display data; a second input end, configured to receive current boundary pixel data in another integrated circuit; a processing circuit, configured to carry out a sub-pixel rendering calculation on current sub-pixel data in the display data received by the display driving integrated circuit on the basis of the current boundary pixel data to obtain compensated pixel data; and an output circuit, configured to use the compensated pixel data for displaying.

At least an embodiment of the present disclosure further provides a multi-integrated circuit-driven display screen, which comprises: at least a first driven region and a second driven region successively arranged; and a first integrated circuit and a second integrated circuit for respectively driving the first driven region and the second driven region. In the two adjacent driven regions, the first integrated circuit is configured to send current boundary pixel data stored in the first integrated circuit to the second integrated circuit, and the second integrated circuit is configured to carry out a sub-pixel rendering calculation on the current boundary pixel data and current sub-pixel data stored in the second integrated circuit.

For example, in the multi-integrated circuit-driven display screen according to an embodiment of the present disclosure, the current boundary pixel data is current pixel data which is positioned at a junction of the two adjacent driven regions in the display screen and driven by the first integrated circuit.

For example, in the multi-integrated circuit-driven display screen according to an embodiment of the present disclosure, the driven regions are transversely arranged side by side, the current boundary pixel data is a longitudinal pixel at the junction of the adjacent driven regions, and a sub-pixel rendering calculation is carried out on the current boundary pixel data and the current sub-pixel data by transverse color borrowing; or, the driven regions are longitudinally arranged side by side, the current boundary pixel data is a transverse pixel at the junction of the adjacent driven regions, and a sub-pixel rendering calculation is carried out on the current boundary pixel data and the current sub-pixel data by longitudinal color borrowing.

For example, in the multi-integrated circuit-driven display screen according to an embodiment of the present disclosure, the current boundary pixel data is a voltage signal.

For example, in the multi-integrated circuit-driven display screen according to an embodiment of the present disclosure, the first integrated circuit is further configured to read grayscale information of the boundary pixel and carry out a gamma operation on the grayscale information to obtain the voltage signal; and the second integrated circuit is further configured to carry out a de-gamma operation on the voltage signal to obtain the grayscale information, and the second integrated circuit carries out a sub-pixel rendering calculation on the grayscale information and the current sub-pixel data stored in the second integrated circuit.

At least an embodiment of the present disclosure further provides a display apparatus, which comprises the multi-integrated circuit-driven display screen according to any one of the embodiments of the present disclosure.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the present disclosure and thus are not limitative of the present disclosure.

FIG. 1 is a flow chart of a display driving method of a plurality of integrated circuits provided by an embodiment of the present disclosure;

FIG. 2 is a schematic diagram of a multi-integrated circuit-driven display screen provided by an embodiment of the present disclosure; and

FIG. 3 is a schematic diagram of a display driving integrated circuit provided by an embodiment of the present disclosure.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

Hereinafter, various embodiments of the present disclosure will be described in detail with reference to the accompanying drawings. It should be noted that in the drawings, the same reference numerals are given to the components having substantially the same or similar structures and functions, and the repeated description thereof will be omitted.

Currently, small and medium-sized OLED display screens mostly adopt a Sub-Pixel Rendering (SPR) technology to improve image display quality. For example, the SPR technology may adopt a color borrowing principle to implement the display of a high-resolution image so as to improve the display quality of the image. However, when the display screen is a multi-integrated circuit (IC) spliced screen, each IC independently drives one driven region on the display screen, and the pixel data of the tail end of an image displayed by the driven region driven by a previous IC cannot be acquired by a next IC, when the next IC is carrying out a SPR calculation, resulting in that the data of a previous column of sub-pixels cannot be recorded in a first column of Red/Blue (R/B) sub-pixels of the next IC and then when the driven region driven by the next IC carries out displaying, a data failure phenomenon may be generated, i.e., a color borrowing failure may be generated at the edge of an adjacent IC driven region, and red and blue sub-pixels form a dark line at the edge, so as to cause the problem of poor display.

At least one embodiment of the present disclosure provides a display driving method of a plurality of integrated circuits. The plurality of integrated circuits include a first integrated circuit and a second integrated circuit. The driving method includes: sending current boundary pixel data driven by the first integrated circuit to the second integrated circuit; and carrying out a sub-pixel rendering calculation in the second integrated circuit on the current boundary pixel data and current sub-pixel data stored in the second integrated circuit to correct the current sub-pixel data.

At least one embodiment of the present disclosure further provides a display driving method of a first integrated circuit, a display driving integrated circuit, a multi-integrated circuit-driven display screen and a display apparatus.

According to the display driving method of the plurality of integrated circuits provided by the above-mentioned embodiment of the present disclosure, in an aspect, the current boundary pixel data driven by the first integrated circuit is sent to the second integrated circuit, and when the second integrated circuit carries out a sub-pixel rendering operation, a missing value in a first column/row of pixel data transmitted by the second integrated circuit to the driven region driven by the second integrated circuit is at least complemented by the current boundary pixel data, and the pixel data outputted to the driven region by the second integrated circuit is corrected, so as to avoid the dark line at the boundary of two adjacent driven regions; and in another aspect, the realization of the driving method is simple and direct and there is no need to redevelop the driving algorithm of the integrated circuits, which reduces the complexity of an image cutting algorithm at an Application Processor (AP) side.

Hereinafter, the embodiments of the present disclosure will be further illustrated in detail in connection of the drawings and the embodiments. It should be understood that the particular embodiments described herein merely are used for explaining the related invention, but not limitative of the embodiments of the present disclosure. In addition, it also should be noted that for ease of description, only parts related to the embodiments of the present disclosure are shown in the drawings.

It should be noted that in case of no conflict, the embodiments of the present disclosure and characteristics in the embodiments may be combined mutually. Hereinafter, the embodiments of the present disclosure will be illustrated in detail with reference to the drawings.

One example of an embodiment of the present disclosure provides a display driving method of a plurality of integrated circuits, and the driving method, for example, is used for an OLED display panel, a liquid crystal display panel, etc. For example, the plurality of integrated circuits may include a first integrated circuit and a second integrated circuit, but it should be noted that the embodiments of the present disclosure are not limited thereto, and the plurality of integrated circuits may further include more integrated circuits to transmit pixel data to the display panel so as to drive the display panel to display images.

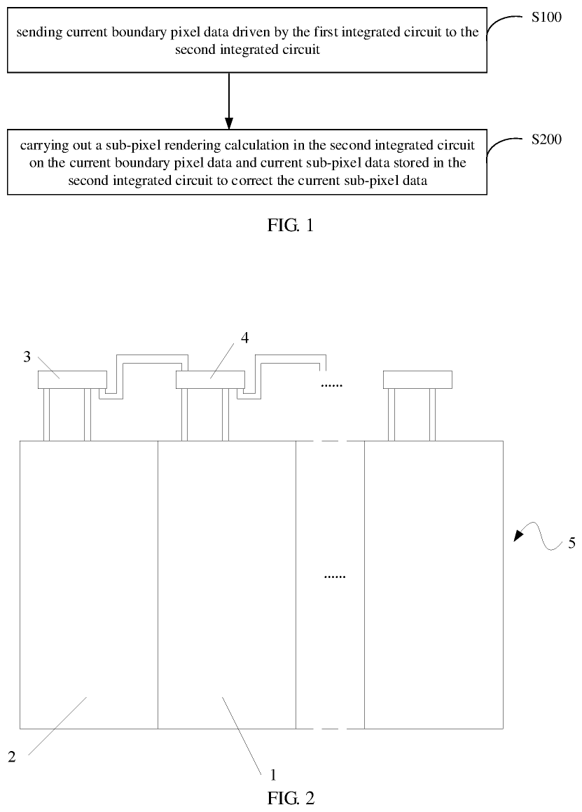

As shown in FIG. 1, the display driving method of the plurality of integrated circuits, as provided by the embodiment of the present disclosure, includes the following steps.

S100: sending current boundary pixel data driven by the first integrated circuit to the second integrated circuit.

In order to improve a resolution of a display screen, one IC is not enough to drive the entire display screen, and in this case, a plurality of ICs are required to drive the same display screen together. The number of the ICs specifically adopted for driving the same display screen may be determined according to the conditions such as the size, the resolution of the display screen. When the same display screen is driven by a plurality of ICs, it may be considered that the display screen is divided into a plurality of driven regions, and for example, each driven region may be driven by one IC. For example, the plurality of driven regions are successively distributed side by side on the display screen. With reference to FIG. 2, the driven regions may be transversely arranged side by side, and in two adjacent driven regions, the driven region on the left side is a first driven region 2, the driven region on the right side is a second driven region 1; and for example, the IC for driving the first driven region 2 is used as a first IC3, and the IC for driving the second driven region 1 is used as a second IC4.

It should be noted that the arrangement mode includes, but is not limited to that shown in FIG. 2, and the driven regions may also be longitudinally arranged side by side. For example, in two adjacent driven regions, the upper one is the first driven region, the lower one is the second driven region, the IC for driving the first driven region is the first IC, and the IC for driving the second driven region is the second IC.

When the display screen carries out displaying, a system segments the content to be displayed according to the number of the ICs. For example, when the display screen is driven by two ICs and the display screen needs to display one image, the system segments the image into two portions and sends one portion to each IC, and the corresponding ICs drive the corresponding driven regions of the display screen to carry out displaying according to the received portions.

When the display screen is driven, the first IC3 reads current boundary pixel data driven by the first IC3, and sends the current boundary pixel data to the second IC4.

S200: carrying out a sub-pixel rendering calculation in the second integrated circuit on the current boundary pixel data and current sub-pixel data stored in the second integrated circuit to correct the current sub-pixel data.

For example, the current sub-pixel data may be stored in a storage of the second IC4, and may be read by the second IC4 from the storage as required.

For example, after the second IC4 receives the current boundary pixel data, the current boundary pixel data is used as a color borrowing sub-pixel value for the second IC4 to carry out a first column/row SPR calculation, and participates in the SPR calculation of the second IC4.

For example, the process of the SPR calculation herein may include, but is not limited to: the first IC3 sends the current boundary pixel data (i.e., original data corresponding to a boundary portion of the image driven by the first IC3) to the second IC4, the second IC4 reads the current boundary pixel data, the current boundary pixel data is stored in a storage unit of the second IC4, a calculation unit of the second IC4 reads the current boundary pixel data from the storage unit and carries out a mixture calculation of same-color sub-pixel values of adjacent pixels by using a first column/row of pixels of the second IC4, and in the mixture calculation, only the same-color R/B sub-pixel values are subjected to the mixture calculation, and Green (G) sub-pixel values are not processed. It should be noted that the embodiments below are the same as the above, and are not repeated herein.

Therefore, by adopting the above-mentioned solution, the current boundary pixel data driven by the first IC3 is sent to the second IC4, and when the second IC4 carries out the SPR operation, the current boundary pixel data at least complements the missing value in the first column/row of pixel data of the second IC4 to correct the output data of the second IC4, so as to avoid the dark line at the boundary of two adjacent driven regions. In addition to eliminating the dark line, the above-mentioned solution also has the advantages of simple and direct implementation mode and so on, and there is no need to redevelop the driving algorithm of the ICs, which reduces the complexity of an image cutting algorithm at the AP side.

For example, in this embodiment, the current boundary pixel data is current pixel data which is positioned at a junction of two adjacent driven regions in the display screen and driven by the first IC3. In practical uses, the current pixel data is at least one column or one row of pixel data at a portion of the first driven region which is adjacent to the second driven region.

For example, carrying out the sub-pixel rendering calculation in the second integrated circuit on the current boundary pixel data and the current sub-pixel data stored in the second IC may further include: transversely arranging individual driven regions side by side, the current boundary pixel data being a longitudinal pixel at the junction of the adjacent driven regions, and carrying out the SPR calculation on the current boundary pixel data and the current sub-pixel data by transverse color borrowing; or, longitudinally arranging individual driven regions side by side, the current boundary pixel data being a transverse pixel at the junction of the adjacent driven regions, and carrying out the SPR calculation on the boundary pixel data and the current sub-pixel data by longitudinal color borrowing. For example, the transverse color borrowing represents transverse transmission (i.e., transmission from left to right or transmission from right to left) of the boundary pixel data; and the longitudinal color borrowing represents longitudinal transmission (i.e., transmission from top to bottom or transmission from bottom to top) of the boundary pixel data.

For example, the current boundary pixel data is a voltage signal. For example, the processing process of the first integrated circuit includes: the first IC3 firstly reads grayscale information of a boundary pixel and carries out the processing of a gamma operation and the like on the grayscale information so as to obtain the voltage signal corresponding to the grayscale information (i.e., the grayscale information of the current boundary pixel is converted into the corresponding voltage signal). For example, the processing process of the second integrated circuit includes: the second IC4 receives the voltage signal (i.e., the current pixel data) transmitted by the first IC3 through an Input/Output (I/O) interface and carries out a de-gamma operation on the voltage signal to obtain the grayscale information corresponding to the voltage signal, and the second IC4 carries out the SPR calculation on the grayscale information and the current sub-pixel data stored in the second IC4 so as to obtain corrected sub-pixel data. For example, the second IC4 may further: carry out the gamma operation on the corrected sub-pixel data so as to convert the corrected sub-pixel data into the voltage signal, and transmit the voltage signal to the second driven region for driving the second driven region, so as to solve the problem of displaying dark line.

It should be noted that in at least one embodiment, the display driving method of the plurality of ICs may further include an operation of reversely transmitting the boundary pixel data in the above-mentioned driving method, i.e., include: sending current boundary pixel data driven by the second integrated circuit to the first integrated circuit; carrying out a sub-pixel rendering calculation in the first IC on the current boundary pixel data driven by the second integrated circuit and current sub-pixel data stored in the first integrated circuit. The working principle of transmitting the current boundary pixel data of the second integrated circuit to the first integrated circuit is similar with the working principle of transmitting the current boundary pixel data of the first integrated circuit to the second integrated circuit, and is not repeated herein.

It should be noted that in the embodiments of the present disclosure, the flow of the display driving method of the plurality of integrated circuits may include more or less operations, and those operations may be executed sequentially or in parallel. The flow of the driving method described above includes a plurality of operations carried out according to a specific sequence, but it should be clearly known that the sequence of the plurality of operations is not limited. The driving method described above may be executed once, or may also be repeatedly executed according to preset conditions.

At least one embodiment of the present disclosure further provides a driving method of an integrated circuit, including: receiving current boundary pixel data in another integrated circuit (for example, a second integrated circuit); carrying out a sub-pixel rendering calculation on current sub-pixel data stored in a first integrated circuit on the basis of the current boundary pixel data so as to acquire compensated pixel data; and transmitting the compensated pixel data to a driven region connected with the first integrated circuit so as to drive the driven region to carry out displaying. For example, the driven region driven by the first integrated circuit and a driven region driven by the second integrated circuit are successively arranged.

For example, the current boundary pixel data is a voltage signal, and after being acquired, the current boundary pixel data may be subjected to the de-gamma operation to convert the voltage signal into grayscale information so as to carry out the sub-pixel rendering calculation on the grayscale information. After pixel rendering is carried out, the gamma operation may also be carried out on the grayscale information, and a result after the gamma operation is output to a second driven region to carry out displaying.

It should be noted that the display driving method of the integrated circuit in this embodiment is similar to the display driving method of the plurality of integrated circuits, and is not repeated herein.

As shown in FIG. 2, an embodiment of the present disclosure further provides a multi-integrated circuit-driven display screen. For example, the multi-integrated circuit-driven display screen 5 includes at least a first driven region 2 and a second driven region 1 which are successively arranged, and a first IC3 and a second IC4 which are used for respectively driving the first driven region 2 and the second driven region 1. For example, the first driven region 2 is connected with the first IC3, and the second driven region 1 is connected with the second IC4. For example, in two adjacent driven regions (for example, the first driven region 2 and the second driven region 1), the first IC3 is used for sending current boundary pixel data stored in the first IC3 to the second IC4, and the second IC4 is used for carrying out a SPR calculation on the current boundary pixel data and current sub-pixel data stored in the second IC4.

As shown in FIG. 2, the same display screen 5 is divided into a plurality of driven regions, and for example, the plurality of driven regions are successively arranged side by side, and each driven region is driven by one independent IC. It should be noted that the embodiment of the present disclosure is not limited thereto. For example, at least one I/O interface of the first IC3 is connected with a corresponding I/O interface of the second IC4, the first IC3 is configured to send the current boundary pixel data stored in the first IC3 to the second IC4 by the I/O interface, and the second IC4 is used for carrying out the SPR calculation on the current boundary pixel data and the current sub-pixel data stored in the second IC4.

A method for eliminating a dark line, which is adopted by the multi-IC-driven display screen, may refer to the description of the above-mentioned display driving method of the plurality of ICs, and is not repeated herein.

For example, the current boundary pixel data is current pixel data which is positioned at a junction of the two adjacent driven regions in the display screen and driven by the first IC3.

For example, individual driven regions included in the display screen 5 are transversely arranged side by side, the current boundary pixel data is a longitudinal pixel at the junction of adjacent driven regions, and an SPR calculation is carried out on the current boundary pixel data and the current sub-pixel data by transverse color borrowing; or, individual driven regions are longitudinally arranged side by side, the current boundary pixel data is a transverse pixel at the junction of adjacent driven regions, and a SPR calculation is carried out on the current boundary pixel data and the current sub-pixel data by longitudinal color borrowing.

For example, the current boundary pixel data is a voltage signal.

For example, in this embodiment, the processing process of the first integrated circuit is that: the first IC3 reads grayscale information of a boundary pixel and carries out the processing of a gamma operation and the like on the grayscale information to obtain the voltage signal. The processing process of the second integrated circuit is that: the second IC4 carries out a de-gamma operation on the voltage signal received by the second IC4 to acquire the grayscale information corresponding to the voltage signal, and the second IC4 carries out a SPR calculation on the grayscale information and the current sub-pixel data stored in the second IC4 so as to obtain corrected sub-pixel data.

For example, the processing process of the second IC4 may further include: carrying out the gamma operation on the corrected sub-pixel data so as to convert the corrected sub-pixel data into the voltage signal, and transmitting the voltage signal to the second driven region connected with the second IC4 for driving the second driven region, so as to solve the problem of displaying dark line.

It should be noted that the display screen 5 may further include other conventional components, which may depend on actual requirements, and the embodiments of the present disclosure do not make any limit thereto.

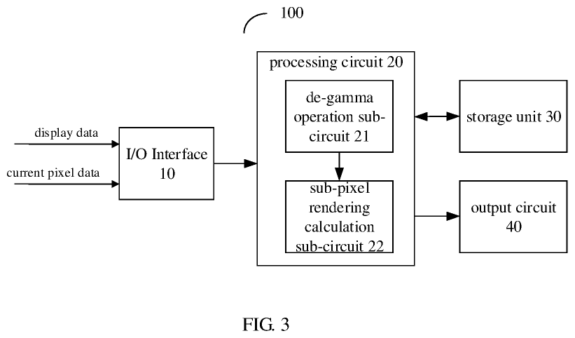

FIG. 3 is a schematic block diagram of a display driving IC provided by one embodiment of the present disclosure. As shown in FIG. 3, the display driving IC 100 includes an I/O interface 10, a processing circuit 20, a storage circuit 30 and an output circuit 40.

For example, in the embodiment of the present disclosure, the I/O interface 10 includes a plurality of ports (not shown in detail in the drawing). For example, one I/O interface is used as a first input end and configured to receive display data; and another I/O interface is used as a second input end and configured to receive current boundary pixel data in another IC. For example, the display data includes a portion of an image, which is to be displayed by the display screen and corresponds to the integrated circuit. For example, a driven region connected with the above-mentioned another integrated circuit and a driven region connected with the display driving IC are successively arranged. It should be noted that the embodiments of the present disclosure are not limited thereto, and according to the actual situation, the display driving integrated circuit may further include more I/O interfaces 10.

The processing circuit 20, for example, includes a de-gamma operation unit (or sub-circuit) 21 and a sub-pixel rendering calculation unit (or sub-circuit) 22. For example, the processing circuit 20 is configured to carry out a sub-pixel rendering calculation on the current sub-pixel data in the display data received by the display driving integrated circuit on the basis of the current boundary pixel data so as to acquire compensated pixel data. For example, the current boundary pixel data is acquired from another integrated circuit by the first input end. The current sub-pixel data in the display data, for example, is stored in the storage unit 30, and as required, may be called by the processing circuit 20 from the storage unit 30. For example, the de-gamma operation unit 21 is configured to convert the received current boundary pixel data (the voltage signal) into the grayscale information for carrying out the sub-pixel rendering calculation. For example, the SPR calculation unit 22 is configured to carry out the sub-pixel rendering calculation on the current sub-pixel data in the display data received by the display driving integrated circuit on the basis of the current boundary pixel data, and the specific process thereof may refer to the related illustration of the display driving method of the plurality of integrated circuits.

For example, the storage unit 30 is configured to store the current sub-pixel data in the display data and store other data generated in the display driving method of the plurality of integrated circuits or other various applications. The storage unit 30, for example, may be any of various proper types of storages, such as a semiconductor storage.

The output circuit 400, for example, is configured to output the compensated pixel data, which is acquired by the sub-pixel rendering calculation unit 22, to the driven region connected with the display driving integrated circuit 100 so as to drive the driven region to correspondingly display images.

It should be noted that in the embodiments of the present disclosure, there may be more or less circuits, and the connection relationship among various circuits is not limited and may be determined according to actual requirements. A specific constitution mode of each circuit is not limited, and each circuit may be constituted by an analog device according to circuit principles, may also be constituted by a digital chip, or be constituted in other proper modes.

An embodiment of the present disclosure further provides a display apparatus, which include the above-mentioned multi-integrated circuit-driven display screen.

It should be noted that the display apparatus in this embodiment may be any product or component with a display function, e.g., a liquid crystal panel, a liquid crystal television, a display, an OLED panel, an OLED television, an electronic paper display apparatus, a mobile phone, a tablet personal computer, a notebook computer, a digital photo frame, a navigator, etc. The display apparatus may further include other conventional components such as a display panel, and the embodiments of the present disclosure do not make any limit thereto.

The technical effects of the display apparatus provided by the embodiments of the present disclosure may refer to the corresponding description related to the multi-integrated circuit-driven display screen 5 in the above-mentioned embodiment, and are not repeated herein.

The following statements should be noted:

(1) The accompanying drawings involve only the structure(s) in connection with the embodiment(s) of the present disclosure, and other structure(s) can be referred to common design(s).
(2) In case of no conflict, features in one embodiment or in different embodiments can be combined to obtain new embodiment(s).

What are described above is related to the illustrative embodiments of the disclosure only and not limitative to the scope of the disclosure; the scopes of the disclosure are defined by the accompanying claims.

1. A display driving method of a plurality of integrated circuits, the plurality of integrated circuits comprising a first integrated circuit and a second integrated circuit, the display driving method comprising:
sending current boundary pixel data driven by the first integrated circuit to the second integrated circuit; and
carrying out a sub-pixel rendering calculation in the second integrated circuit on the current boundary pixel data and first current sub-pixel data to correct the first current sub-pixel data, wherein the first current sub-pixel data is stored in the second integrated circuit.

2. The display driving method of the plurality of integrated circuits according to claim 1, wherein the current boundary pixel data is current pixel data which is positioned at a junction of two adjacent driven regions in a display screen and driven by the first integrated circuit.

3. The display driving method of the plurality of integrated circuits according to claim 2, wherein the carrying out the sub-pixel rendering calculation in the second integrated circuit on the current boundary pixel data and the first current sub-pixel data comprises:
carrying out the sub-pixel rendering calculation on the current boundary pixel data and the first current sub-pixel data by transverse color borrowing, in a case where the driven regions are transversely arranged side by side, and the current boundary pixel data is a longitudinal pixel at the junction of the adjacent driven regions; or
carrying out the sub-pixel rendering calculation on the current boundary pixel data and the first current sub-pixel data by longitudinal color borrowing, in a case where the driven regions are longitudinally side by side, the current boundary pixel data is a transverse pixel at the junction of the adjacent driven regions.

4. The display driving method of the plurality of integrated circuits according to claim 1, wherein the current boundary pixel data is a voltage signal.

5. The display driving method of the plurality of integrated circuits according to claim 4, further comprising:
reading grayscale information of a boundary pixel by the first integrated circuit, and carrying out a gamma operation on the grayscale information to obtain the voltage signal; and
carrying out a de-gamma operation on the voltage signal by the second integrated circuit to obtain the grayscale information, and carrying out by the second integrated circuit the sub-pixel rendering calculation on the grayscale information and the first current sub-pixel data.

6. The display driving method of the plurality of integrated circuits according to claim 1, further comprising:
sending current boundary pixel data driven by the second integrated circuit to the first integrated circuit; and
carrying out a sub-pixel rendering calculation in the first integrated circuit on the current boundary pixel data driven by the second integrated circuit and second current sub-pixel data, wherein the second current sub-pixel data is stored in the first integrated circuit.

7. A display driving method, comprising:
receiving current boundary pixel data from a first integrated circuit;
carrying out a sub-pixel rendering calculation on current sub-pixel data stored in a second integrated circuit based on the current boundary pixel data to obtain compensated pixel data; and
transmitting the compensated pixel data to a driven region connected with the second integrated circuit to drive the driven region to display.

8. A display driving integrated circuit for implementing the display driving method of claim 7, comprising:
a first input end, configured to receive display data, wherein the display data comprises the current sub-pixel data;
a second input end, configured to receive the current boundary pixel data from the first integrated circuit;
a processing circuit, configured to carry out the sub-pixel rendering calculation on the current sub-pixel data in the received display data on the basis of the current boundary pixel data to obtain the compensated pixel data; and
an output circuit, configured to transmit the compensated pixel data to a driven region to drive the driven region to display.

9. A display screen, comprising:
a first driven region and a second driven region successively arranged; and
a first integrated circuit and a second integrated circuit for respectively driving the first driven region and the second driven region,
wherein the first integrated circuit is configured to send current boundary pixel data stored in the first integrated circuit to the second integrated circuit, and the second integrated circuit is configured to carry out a sub-pixel rendering calculation on the current boundary pixel data and current sub-pixel data, wherein the current sub-pixel data is stored in the second integrated circuit.

10. The display screen according to claim 9, wherein the current boundary pixel data is current pixel data which is positioned at a junction of the two adjacent driven regions in the display screen and driven by the first integrated circuit.

11. The display screen according to claim 10, wherein
the driven regions are transversely arranged side by side, the current boundary pixel data is a longitudinal pixel at the junction of the adjacent driven regions, and a sub-pixel rendering calculation is carried out on the current boundary pixel data and the current sub-pixel data by transverse color borrowing; or
the driven regions are longitudinally arranged side by side, the current boundary pixel data is a transverse pixel at the junction of the adjacent driven regions, and a sub-pixel rendering calculation is carried out on the current boundary pixel data and the current sub-pixel data by longitudinal color borrowing.

12. The display screen according to claim 9, wherein the current boundary pixel data is a voltage signal.

13. The display screen according to claim 12, wherein
the first integrated circuit is further configured to read grayscale information of the boundary pixel and carry out a gamma operation on the grayscale information to obtain the voltage signal; and
the second integrated circuit is further configured to carry out a de-gamma operation on the voltage signal to obtain the grayscale information, and the second integrated circuit carries out a sub-pixel rendering calculation on the grayscale information and the current sub-pixel data stored in the second integrated circuit.

14. A display apparatus, comprising the display screen according to claim 9.

15. The display driving method of the plurality of integrated circuits according to claim 2, wherein the current boundary pixel data is a voltage signal.

16. The display driving method of the plurality of integrated circuits according to claim 3, wherein the current boundary pixel data is a voltage signal.

17. The display screen according to claim 10, wherein the current boundary pixel data is a voltage signal.

18. The display screen according to claim 11, wherein the current boundary pixel data is a voltage signal.

19. A display apparatus, comprising the display screen according to claim 10.

20. A display apparatus, comprising the display screen according to claim 11.
